(19) United States
(12) Patent Application Publication
(10) Pub. No.: US 2023/0365170 A1
(43) Pub. Date: Nov. 16, 2023

(54) METHOD AND SYSTEM FOR DETERMINING A TARGET PROFILE OF THE TRACK TO CORRECT THE GEOMETRY

(71) Applicant: PLASSER & THEURER EXPORT VON BAHNBAUMASCHINEN GESELLSCHAFT M.B.H., Wien (AT)

(72) Inventors: Florian Auer, Wien (AT); Michael Berghuber, Linz (AT); Fabian Hinterberger, Linz (AT); Bernhard Metzger, Chesapeake, VA (US); Krzysztof Wilczek, Wien (AT)

(21) Appl. No.: 18/245,585

(22) PCT Filed: Aug. 24, 2021
(86) PCT No.: PCT/EP2021/073315

§ 371 Date: Mar. 16, 2023

(30) Foreign Application Priority Data
Sep. 16, 2020 (AT) A50782/2020

(51) Int. Cl. B61K 9/08; G01C 7/04; B61L 25/02

(52) U.S. Cl. CPC B61K 9/08; G01C 7/04; B61L 25/025; B61L 2205/04

(57) ABSTRACT

A method for determining a target geometry of a track for correcting the geometry of the track. An actual geometry of the track is detected first on a track section by a measuring system and the target geometry is calculated on the basis of the actual track geometry afterwards by way of a computing unit. Actual position points of the track are detected along the track section by a position detection system, with at least one actual position point being given to the computing unit as a point of restraint, and with the target geometry being calculated by the computing unit such that the target geometry is adapted to the actual geometry as a sequence of geometric track alignment design elements and is placed through the preset point of restraint. The method achieves a significant increase in quality compared to the known compensation method using pre-measurement.

### FIELD OF TECHNOLOGY

The invention relates to a method for determining a target geometry of a track to correct the geometry of the track, with an actual geometry of the track being detected first on a track section by means of a measuring system and with a compensation calculation being carried out afterwards by means of a computing unit in order to calculate the target geometry on the basis of the actual geometry. The invention further relates to a system for carrying out the method.

### PRIOR ART

In case of a ballasted track, the position of a track panel in the ballast bed is affected by traffic and climatic influences. A specifically provided track inspection vehicle is used to take regular measurements to evaluate the current track geometry (layout of the track), especially prior to maintenance work. A suitably equipped track maintenance machine can also be used as a track inspection vehicle. The track geometry is usually defined by the horizontal position (alignment) and the vertical position (track inclination). For determining an absolute track geometry, the position in relation to an external reference system is also required.

In conventional measuring methods, external reference points located next to the track are used, which are attached to fixed structures such as electric poles. Such external reference points may be determined as marking bolts or other marking objects. Likewise, land surveying systems or GNSS systems can be used to determine external reference points. The intended position of each reference point in relation to the track is documented in directories. In this way, the absolute track geometry is exactly defined on main railway lines (=design geometry of the track).

In addition, a target geometry of the track can be determined by means of internal references. This involves the track alignment design being specified by a sequence of track alignment design elements in terms of their length and size. For straight lines, specifying the length is sufficient. Transition curves and curved tracks are each determined by specifying a length and a curved track size. So-called track main points indicate a change between different track alignment design elements, especially for circular and transition curves as well as gradient changes.

Thus, the horizontal position of the track is composed of the track curvature as a sequence of straight sections, transition curves, and circular curves. The vertical position of the track is determined by specifying the inclination as well as gradient changes including their vertical curve radii. The superelevation course of the track is defined by its superelevation sequence including superelevation ramps. When determining the track geometry, superelevation and alignment of the track are harmonised in accordance with the track alignment design guidelines (e.g. EN 13803).

Restoring a desired high-quality track position can be achieved using the so-called precision method. In this method, the exact, absolute track geometry (design geometry) is known through a sequence of defined track alignment design elements and through the geodetic position of the track main points. Prior to a maintenance operation, the existing track geometry and the track position are measured in relation to defined reference points (fixed points). The measuring result is compared with the design geometry, with lifting and lining values for correcting the track geometry being determined from a detected difference. This method is very accurate and suitable for high-speed lines that require optimised maintenance. The geometry parameters must be processed reliably and a control measurement of the geodetic reference points must be carried out regularly.

For cost reasons, the so-called compensation method is used for plain lines with lower requirements. This method can be carried out without any known design geometry of the track. For example, a measuring system of a track tamping machine can be used, in which measuring chords (moving chords), serving as a reference system, are tensioned between measuring trolleys guided along the track. Various embodiments of this moving-chord measuring principle can be found, for example, in DE 10 2008 062 143 B3 or in DE 103 37 976 A1. In this principle, existing track position errors are reduced according to the ratio between the spans of the measuring chords and the longitudinal distance of the measuring trolleys. In 4-point methods, the existing relative track geometry is detected by an additional measuring chord. A corresponding machine and a method are disclosed in AT 520 795 A1.

In a compensation method with prior measurement of the track, the existing relative actual geometry of the track is measured with a preliminary run of the track tamping machine or a track inspection vehicle. For this purpose, a so-called inertial measuring unit (IMU) is used in modern track inspection vehicles. An inertial measuring system is described in the technical journal Eisenbahningenieur (52) 9/2001 on pages 6 to 9. DE 10 2008 062 143 B3 also discloses an inertial measuring principle for detecting a track position. Based on this measurement, a compensation calculation is carried out in which a previously unknown target geometry is calculated on the basis of the actual geometry.

The actual geometry of the track is usually recorded in the form of a versine and longitudinal-level progression as well as a sequence of superelevation values. Based on this recording, a computing unit calculates an electronic versine compensation, taking into account a previously determined speed category of the track as well as preset upper limits for displacement and lifting values. The measured versines are smoothed in order to obtain a profile that is as ideal as possible for the given conditions. The position of the transition points between the track alignment design elements (track main points) is determined in the course of the compensation calculation.

In a next step, the resulting displacements and liftings are calculated from the versines by applying a digital filter by which the track must be corrected so that the calculated versine profile can be set. Thus, the results of these further calculations are lifting and lining values (correction values) for correcting the geometry of the track by means of the track tamping machine.

A disadvantage of a repeated use of the compensation method is the drifting away of the track main points from their original positions (according to an originally determined design geometry). Thus, the ageing of a track leads to an increasing deviation from the original design geometry despite corrections made by means of compensation methods.

Minor position changes of the track main points usually do not pose difficulties. The track alignment design often leaves sufficient flexibility for determining the track position. Difficulties, however, arise with so-called points of restraint or constraints such as bridges, tunnels, or level crossings. These points leave no scope for relocating the track. According to prior art, it is therefore common to set the displacement values to zero at these points in the compensation calculation.

### Presentation of the Invention

The object of the invention is to improve a method of the kind mentioned above in such a way as to achieve a higher quality of the preset target course of the track than with the compensation method. A further object of the invention is to indicate a corresponding system.

According to the invention, these objects are achieved by way of a method according to claim 1 and a system according to claim 10. Dependent claims indicate advantageous embodiments of the invention.

It is provided that actual position points of the track are detected along the track section by means of a position detection system, and that at least one actual position point is given to the computing unit as a point of restraint, and that the compensation calculation is carried out by means of the computing unit in such a way that the target geometry is adapted to the actual geometry as a sequence of geometric track alignment design elements and is placed through the preset point of restraint. The basis for the calculation is the actual geometry (relative trajectory) of the track. The track alignment design elements are filtered to the measured location diagram of the track. The measured actual position points (track position trace) are taken into account as a second basis in the compensation calculation for the lifting and lining values. Each actual position point is determined by coordinates in a spatial reference system. For example, a stationary coordinate system with the starting point of a measuring run as its origin is selected. Of course, other coordinate systems can also be used for georeferencing.

Thus, in contrast to the precision method, no reference is made to fixed external reference points and thus to the design geometry. It is not an absolute pre-measurement (surveying) of the track. Compared to the precision method, a lower accuracy is to be expected, but the method according to the invention can be carried out with simpler technical means in an efficient and cost-effective manner.

Compared to the known compensation method using pre-measurement, a significant increase in quality is achieved. The correction values for points of restraints are not only set to zero. According to the invention, the entire calculated target geometry is adapted to at least one preset point of restraint by placing an optimised sequence of defined geometric track alignment design elements through the point of restraint.

In a further development of the method, it is provided that a track point fixed in its position is automatically detected by means of a sensor device and that the actual position point associated with a detected fixed track point is preset as a point of restraint by means of a presetting device. The sensor device includes, for example, optical sensors with pattern recognition to detect typical structures of a level crossing or a bridge. Track points that are structurally fixed in their position can also be marked with optical markers as well as other passive or active markers to enable easy, automated recognition by means of sensors.

In a simple variant, an actual position point is alternatively or additionally preset by an operator by means of a presetting device as a point of restraint. For example, the operator is in a track inspection vehicle for surveying the track section. As soon as the operator detects the crossing of a curved turnout, a bridge without ballast bed or a level crossing with rigid pavement, the currently detected actual position point is preset as the point of restraint. Based on image recordings with assigned coordinates, a subsequent determination of a point of restraint is also possible.

Another improvement provides that the actual position points are detected as GNSS coordinates by means of a GNSS receiving device. The systems used are largely fail-safe and deliver results with sufficient accuracy.

Here, it is useful if the detection of the actual position points is carried out by means of a differential GNSS system in order to increase the accuracy of the position data, if required.

In an advantageous embodiment of the method, the actual geometry of the track is detected by means of an inertial measuring unit, with a time stamp being preset as a common time base for each measuring date, particularly by means of the inertial measuring unit. The inertial measuring unit is very robust against external influences and provides very precise data to detect the actual geometry for the present application. For a comparison with the data of the position detection system, it is useful if the inertial measuring unit provides the time basis for a data synchronisation.

In a further development of this embodiment, a three-dimensional trajectory is determined from measuring data of the inertial measuring unit in an evaluation device, whereby correction values for correcting the geometry of the track are determined from a comparison with the target geometry. The three-dimensional trajectory and the target geometry refer to a common coordinate system, which means that the correction values can be determined with little calculation effort. The determined three-dimensional trajectory is also suitable for descriptive documentation of the track condition prior to a track correction.

Furthermore, it is useful if a separate three-dimensional trajectory is determined for a left rail of the track and for a right rail of the track. Particularly superelevation errors of the track or individual errors with different settlements of the respective rail can be easily recorded in this way. The calculation of the target geometry then takes these special features into account, for example by compensating for individual errors.

Another advantageous embodiment provides that unfiltered measuring data of the detected track section are output by the inertial measuring unit to an evaluation device, that a virtual inertial measurement of the same track section is simulated with the target geometry by means of a simulation device in order to obtain simulated measuring data assuming the target geometry, and that correction values for correcting the geometry of the track are determined by subtracting the simulated measuring data from the unfiltered measuring data of the inertial measuring unit. When using an inertial measuring unit, it can happen that artefacts occur in the unfiltered measuring data, especially when driving in curves. These artefacts result from specific features of the inertial measuring method used. If the same inertial measuring method is applied to the target geometry in virtual form, the same artefacts will occur. By subsequently subtracting the unfiltered measuring data to determine the correction values, the artefacts cancel each other out. This reduces the overall processing capacity required because the sometimes time-consuming digital filtering of the measuring data is no longer necessary.

In a further improvement of the method, at least one detected actual position point which does not lie between a starting point and an end point of a worksite section intended for position correction is determined as a point of restraint for the compensation calculation. This ensures that the determined target geometry in the current worksite section also promotes the quality of future track corrections in adjacent track sections. The maintenance of a track section extending beyond the current worksite section is thus taken into account.

According to the invention, a system to implement one of the methods described above is provided, with a track inspection vehicle for travelling on a track section, comprising a measuring system for detecting an actual geometry of the track, and with a computing unit for calculating a target geometry on the basis of the actual geometry, with the track inspection vehicle comprising a position detection system for detecting actual position points along the track section, with a presetting device being set up for the computing unit for determining at least one actual position point as a point of restraint, and with an algorithm being set up in the computing unit which adapts the target geometry to the actual geometry as a sequence of geometric track alignment design elements and places it through the at least one point of restraint. In this way, the components of the system interact with each other to detect the actual geometry and actual position points and, based on this, to derive the target geometry for correcting the geometry of the track.

In a further development of the system, the track inspection vehicle comprises a sensor device for the automated detection of a track point fixed in its position, with the sensor device being coupled to the presetting device in order to define an actual position point associated to the track point as a point of restraint. The sensor device comprises, for example, several coupled sensors of different design to detect and categorise physical objects of the track. A corresponding method is described in AT 518692 A1 of the same applicant. As soon as an object is categorised as a structurally fixed track point (bridge, level crossing, etc.), the presetting device specifies the corresponding actual position point as a point of restraint. Alternatively or additionally, sensor markers that match sensors arranged on the track inspection vehicle can be arranged on such track points.

A simpler variant provides that the presetting device comprises an operating unit by means of which an actual position point can be set as a point of restraint by an operator. For example, the operating unit comprises a control element which, when actuated, predefines a currently detected actual position point as a point of restraint.

Advantageously, the position detection system comprises a GNSS receiving device, which is, in particular, coupled to position measuring devices for determining the position of the GNSS receiving device in relation to the track. This enables a robust determination of the actual position points with sufficient accuracy in a geodetic reference system.

Furthermore, it is advantageous if the measuring system comprises an inertial measuring unit and, in particular, position measuring devices for determining the position of the inertial measuring unit in relation to the track. Such measuring systems record the actual geometry in a non-contacting manner, which means that high speeds can be achieved during measuring runs. As a GNSS receiving device also provides results in real time, the overall work speed of the entire system is high.

The system is further developed by an evaluation device which is adapted to calculate correction values for correcting the geometry of the track, with a control device of a track maintenance machine being adapted to process the correction values in order to place the track into the preset target geometry by means of a controlled lifting and lining unit. In this way, the system comprises all components to detect an actual geometry and to perform a correction of the track geometry on this basis.

### BRIEF DESCRIPTION OF THE DRAWINGS

In the following, the invention is explained by way of example with reference to the accompanying figures. The following figures show in schematic illustrations:

FIG. 1 Track inspection vehicle on a track

FIG. 2 Location diagram with worksite section and measurement section

FIG. 3 Block diagram for determining correction values

FIG. 4 Diagrams of a track course

FIG. 5 Diagrams of a curved track with transition curves and straight lines

FIG. 6 Location diagram of a track section with actual geometry and target geometry

### DESCRIPTION OF THE EMBODIMENTS

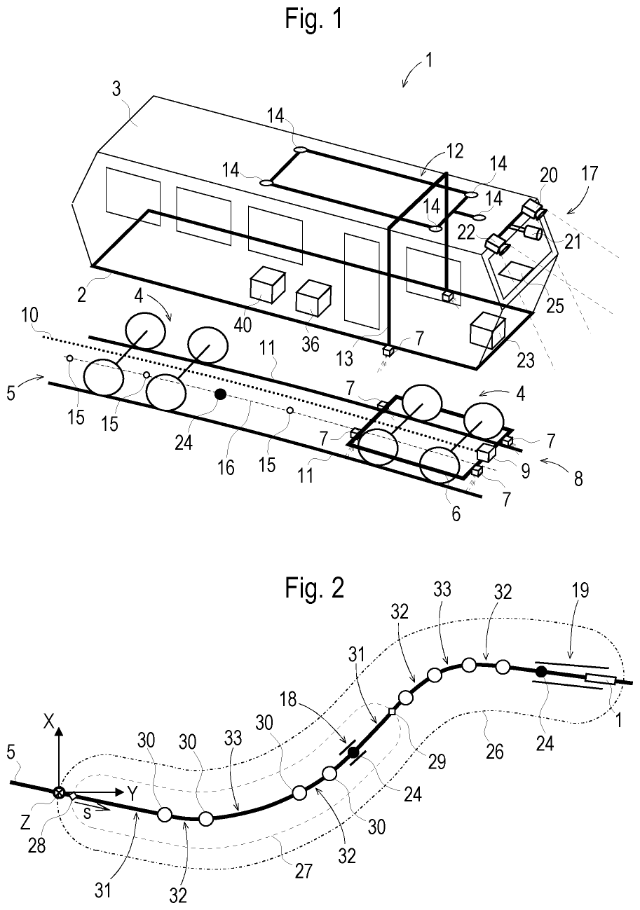

FIG. 1 shows a track inspection vehicle 1 with a vehicle frame 2 on which a railway vehicle body 3 is mounted. The track inspection vehicle 1 is movable on a track 5 by means of rail-based running gears 4. For better illustration, the vehicle frame 2 together with the railway vehicle body 3 is shown in a raised position from the rail-based running gears 4. The track inspection vehicle 1 can also be designed as a track maintenance machine, in particular as a tamping machine. In this case, only one machine is required to survey and correct the track 5.

The rail-based running gears 4 are preferably designed as bogies. A measuring frame 6 is connected to the wheel axles of the bogie so that any movement of the wheels is transmitted to the measuring frame 6 without spring action. Thus, there is only lateral or reciprocal movement of the measuring frame 6 in relation to the track 5. These movements are detected by means of position measuring devices 7 arranged on the measuring frame 6. They are designed, for example, as light section sensors.

The position measuring devices 7 are components of a measuring system 8 mounted on the measuring frame 6, which comprises an inertial measuring unit 9. Measuring data of a trajectory 10 are recorded with the inertial measuring unit 9 during a measuring run, with relative movements of the inertial measuring unit 9 in relation to the track 5 being compensated for by means of the data from the position measuring devices 7. This way, the detection of an actual geometry I of the track 5 is achieved. By means of the measuring data of the position measuring devices 7, the measuring data of the inertial measuring unit 9 can also be transformed to a respective rail 11 of the track 5. The result is a trajectory 10 for each rail 11.

The track inspection vehicle 1 further comprises a position detection system 12, by means of which a current position of the track inspection vehicle 1 can be detected. Due to the known position of the track inspection vehicle 1 in relation to the track 5, the position of the currently travelled track point can also be detected. For example, the position detection system 12 comprises a GNSS receiving device that is rigidly connected to the vehicle frame 2 via a carrier 13. The GNSS receiving device comprises several GNSS antennas 14 arranged in relation to each other for an accurate detection of GNSS positions of the track inspection vehicle 1. In order to record the reciprocal movements of the vehicle frame 2 in relation to the track 5, further position measuring devices 7 are arranged on the vehicle frame 2. Again in this case, light section sensors are used. For a simple embodiment of the invention, one GNSS antenna 14 is sufficient. This way, actual position points 15 of the track 5 or a common centre-line of the track 16 are continuously detected.

An alternative position detection system 12 not shown comprises a radio-based measuring system for real-time localisation. In this system, several transmitter modules are attached to the track inspection vehicle 1. Reference stations located next to the track line include transponders. By means of a continuous distance measurement between the transmitter modules and the transponders, the position of the track inspection vehicle 1 and thus the position of the track point currently being travelled on can be determined in relation to the reference stations. The reference stations are only used to determine the position without reference to the original design geometry of the track 5.

In addition, the track inspection vehicle 1 comprises a sensor device 17 for automatically detecting a track point 18, 19 that is structurally fixed in its position (FIG. 2). Advantageously, the sensor device 17 comprises several sensors 20, 21, 22, the data of which is evaluated together. For example, a video camera 20, a rotating laser scanner 21 and an infrared camera with infrared lighting 22 are used. The sensor device 17 is coupled to a presetting device 23 in order to set an actual position point 15 associated with a fixed track point 18, 19 as a point of restraint 24. As an alternative to the sensor device 17 or in addition to it, the presetting device 23 may comprise an operating unit 25. An actual position point 15 can be preset by an operator as a point of restraint 24 by means of this operating unit 25.

FIG. 2 shows a track 5 that is travelled on by the track inspection vehicle 1. A dash-dotted outline indicates the length of a track section 26 on which the actual geometry I and the actual position points 15 of the track 5 are detected. A dashed outline indicates the length of a worksite section 27 on which the track 5 will be corrected later. The worksite section 27 is shorter than the measured track section 26 and is bounded by a starting point 28 and an end point 29.

On the track section 26 shown, there are two track points 18, 19, which are structurally fixed in their position. These are, for example, a level crossing 18 with rigid pavement and a bridge 19 without ballast bedding. The bridge 19 is located outside of the worksite section 27. During a measuring run, actual position points 15 assigned to these track points 18, 19 are determined as points of restraint 24.

In the example shown, a stationary coordinate system XYZ is used for georeferencing the measuring results, the origin of which is at the starting point of the measuring run. The X-axis points north, the Y-axis points east, and the Z-axis points downwards. During the measuring run, a distance s is further recorded which can be used, in addition to a time stamp, to synchronise the measuring results of the different systems 8, 12, 17.

Track main points 30 are located along the track section 26. These track main points 30 each mark a boundary between a straight line 31 and a transition curve 32 as well as between a transition curve 32 and a circular curve 33. A straight line 31, a transition curve 32, and a circular curve 33 (full curve) are defined as geometric track alignment design elements.

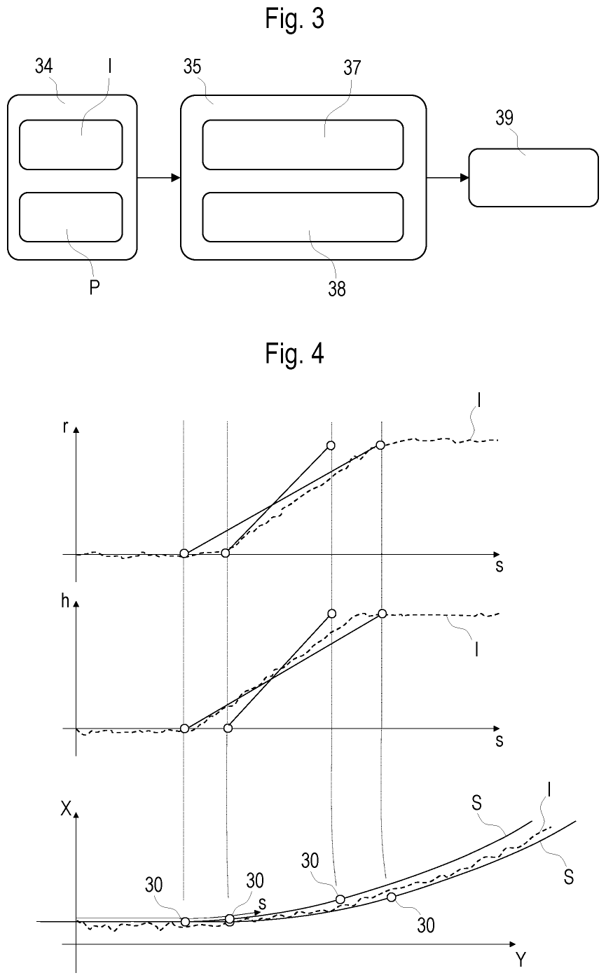

The block diagram in FIG. 3 illustrates the individual steps of the method. First, a pre-measurement 34 is carried out to detect the relative actual geometry I and the GNSS position P of the track 5. The measuring data of the inertial measuring unit 9 and coordinate data for the detected actual position points 15 are available as results.

Subsequently, a compensation calculation 35 is carried out by means of an optimisation algorithm which is set up in a computing unit 36. Specifically, a track-geometry optimisation 37 is performed by forming a track geometry based on the actual geometry I by lining up geometric track alignment design elements 31, 32, 33 to remove track geometry faults. This optimisation process 37 takes place in dependence on a track-position optimisation 38, by lining up and dimensioning track alignment design elements 31, 32, 33 in such a way that the resulting target geometry S of the track 5 is placed through predetermined points of restraint 24.

Boundary conditions for these optimisation processes 37, 38 are formed by the connection points at the borders of the worksite section 27. Specifically, the target geometry S must be placed through the starting point 28 and through the end point 29 of the worksite. Furthermore, the target geometry S must be tangential to the unworked track 5 at these points 28, 29. For example, an optimisation algorithm is used which optimises the deviations between the target geometry S and the actual geometry I as an objective function under the existing constraints (method of least squares).

With the target geometry S preset in this way, a correction-value calculation 39 is carried out in the next step. In a first variant, this is done by means of the three-dimensional trajectory 10, which is derived from the measuring data of the inertial measuring unit 9. The actual geometry I of the track 5 is directly derived from the coordinates of the trajectory 10, so that the correction values can be directly determined from a comparison with the target geometry S. These are usually displacement values (lining values) and lifting values for lateral lining and for lifting the track panel. Preferably, individual lifting values are preset for each rail 11, for example to compensate for individual faults or to adjust superelevations. The correction values are determined by means of an evaluation device 40, which is supplied with the values of the actual geometry I and the target geometry S of the track 5.

In a second variant, the unfiltered measuring data of the inertial measuring unit 9 are used. This eliminates the need to identify the coordinates of the trajectory 10 for the correction-value calculation 39. Instead, an evaluation device 38 carries out a simulation, in which an inertial measurement is simulated. Based on the real measurement of the track section 26 by means of the real inertial measuring unit 9, a virtual measurement of the same track section 26 with the calculated target geometry S is carried out. For this, a virtual inertial measuring unit is used. The real and the virtual measuring unit use the same inertial measuring method. Method-related artefacts occur in both the real and the virtual measurement. By subtracting the obtained measuring data of the actual geometry I and the target geometry S, these artefacts cancel each other out. As a result, the correction values for the corresponding track section 26 are obtained.

The correction values are provided to a control device of a lifting and lining unit of a tamping machine. The tamping machine can simultaneously be designed as the track inspection vehicle 1 described herein. To correct the track geometry, the track 5 is travelled on by the tamping machine after pre-measurement. According to the preset correction values, the track panel is placed to its desired position by means of the lifting and lining unit and is fixed in place by means of a tamping unit. A chord-based measuring system mounted on the tamping machine is used to check the track geometry. Advantageously, a so-called track geometry guiding computer (also called ALC, automatic guiding computer) in the tamping machine comprises the computing unit 36 and the evaluation device 40. The guiding computer serves as the central unit for determining the correction values and for controlling the tamping machine.

FIG. 4 shows a curvature diagram (curvature illustration) and a superelevation diagram (superelevation illustration) in the upper two diagrams. The distance s is plotted on the abscissa. The ordinate of the curvature diagram shows the current curvature or alignment r above the distance s. The ordinate of the superelevation diagram shows the superelevation or level h above the distance s.

In the illustration below, the associated location diagram of the track section 26 is shown in a stationary coordinate system XYZ with the X coordinates and Y coordinates. The track section shown begins with a straight line 31 and then changes into a transition curve 32 with increasing curvature until the curvature remains constant in the subsequent circular curve 33 (full curve).

In the diagrams and in the location diagram, the measured actual geometry I is shown with dashed lines. It is clearly visible that there is no unambiguous position of the track main points 30 for the target geometry S to be determined. Two variants are shown which lead to transition curves 32 of different lengths and thus to different target geometries S. The method according to the invention uses this flexibility to achieve an optimised sequence of the geometric track alignment design elements.

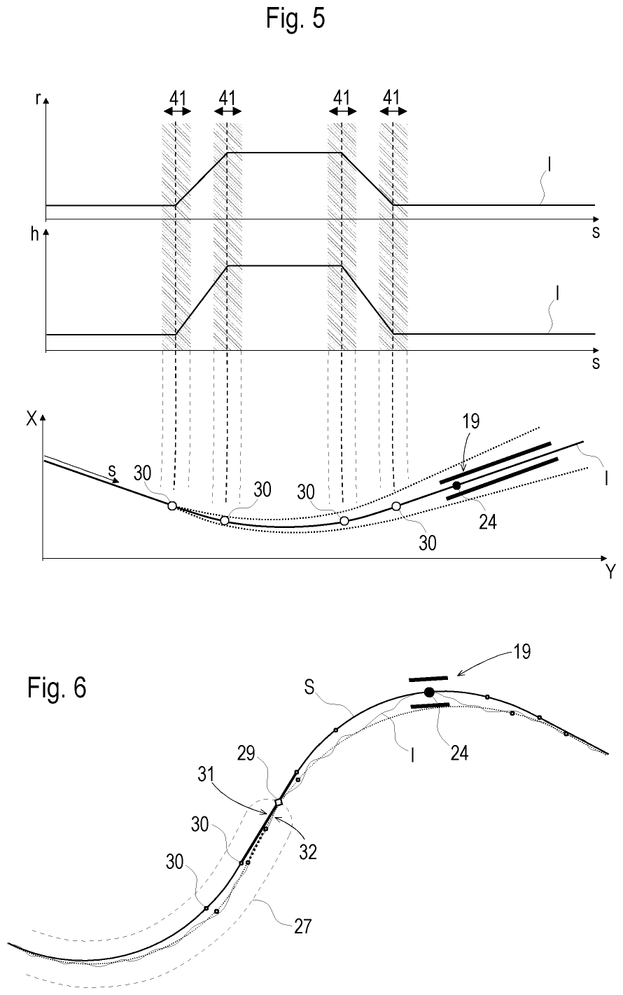

FIG. 5 also shows a curvature diagram, a superelevation diagram, and a location diagram. The solid lines respectively show the target geometry S, which was determined using the method according to the invention. Here, an actual position point 15, which is assigned to a fixed track point 19 (e.g. bridge), is preset as a point of restraint 24. Based on the determined actual geometry I and the preset point of restraint 24, the target geometry S is adapted as a sequence of geometric track alignment design elements of the actual geometry I in such a way that the point of restraint 24 lies on the line of the target geometry S. This results in the correct position for the marked track main points 30. In the location diagram, two examples are marked with dotted lines, which show a possible target geometry according to the conventional compensation method. The track main points 30 deviate from the correct position within a fault range 41 shown in a hatched pattern. Even small mistakes can have a big impact on the resulting location diagram.

With reference to FIG. 6, it is explained that a point of restraint 24 preset outside the worksite also positively influences the target geometry S in the worksite section 27. A location diagram of a track section 26 is shown on which a pre-measurement was carried out by means of the track inspection vehicle 1. The detected actual geometry I is shown with a thin solid line. A dotted line shows a possible target geometry according to the conventional compensation method. In this, the actual geometry I is merely smoothed. It is clearly visible that the marked point of restraint 24 is missed at a fixed track point 18 (e.g. level crossing).

In the method according to the invention, the coordinates of the point of restraint 24 are included in the calculation of the target geometry S. This results in the sequence of geometric track alignment design elements marked with a solid line. Again, track main points 30 indicate the boundaries of the track alignment design elements. In the example shown, the track 5 corrected according to the conventional compensation method would connect to the unworked track with a transition curve 32.

In the method according to the invention, the track 5 continues as a longer straight line 31 at this point due to the included point of restraint 24. Connection angle and position coordinates of the track 5 in the end point 29 of the worksite remain the same. This ensures that an optimal result is achieved in the event of a later correction of the further course of the track. In FIG. 6, the courses of track 5 are strongly exaggerated to illustrate the effect described.

1-15. (canceled)

16. A method for determining a target geometry of a track to correct a geometry of the track, the method comprising:
detecting an actual geometry of the track on a track section by a measuring system;
detecting actual position points of the track along the track section by a position detection system and transmitting at least one actual position point to a computing unit as a preset point of restraint;
calculating the target geometry on a basis of the actual geometry by the computing unit, and thereby calculating the target geometry in such a way that the target geometry is adapted to the actual geometry as a sequence of geometric track alignment design elements and is placed through the preset point of restraint.

17. The method according to claim 16, which comprises automatically detecting a track point that is fixed in its position by way of a sensor device and setting the actual position point associated with a detected fixed track point as the point of restraint by a presetting device.

18. The method according to claim 16, which comprises presetting an actual position point as a point of restraint by an operator by way of a presetting device.

19. The method according to claim 16, which comprises detecting the actual position points as Global Navigation Satellite System coordinates by way of a GNSS receiving device.

20. The method according to claim 19, which comprises detecting the actual position points by a differential GNSS system.

21. The method according to claim 16, which comprises detecting the actual geometry of the track by way of an inertial measuring unit.

22. The method according to claim 21, which comprises providing a time stamp as a common time base for each measuring datum by the inertial measuring unit.

23. The method according to claim 21, which comprises determining a three-dimensional trajectory from measuring data of the inertial measuring unit in an evaluation device, and determining correction values from a comparison with the target geometry to correct the geometry of the track.

24. The method according to claim 21, which comprises outputting unfiltered measuring data of the detected track section by the inertial measuring unit to an evaluation device, and simulating a virtual inertial measurement of the same track section with the target geometry by a simulation device in order to obtain simulated measuring data assuming the target geometry, and determining correction values for correcting the geometry of the track by subtracting the simulated measuring data from the unfiltered measuring data of the inertial measuring unit.

25. The method according to claim 16, which comprises determining at least one detected actual position point which does not lie between a starting point and an end point of a worksite section intended for position correction as a point of restraint for the compensation calculation.

26. A system for implementing the method according to claim 16, the system comprising:
a track inspection vehicle for travelling on a track section, the vehicle including a measuring system for detecting an actual geometry of the track and a position detection system for detecting actual position points along the track section;
a computing unit for calculating a target geometry on a basis of the actual geometry of the track;
a presetting device for said computing unit, for determining at least one actual position point as a point of restraint;
said computing unit being configured to process an algorithm for adapting the target geometry to the actual geometry as a sequence of geometric track alignment design elements and for placing the target geometry through the at least one point of restraint.

27. The system according to claim 26, wherein said track inspection vehicle comprises a sensor device for an automated detection of a track point that is in a fixed position, said sensor device being coupled to said presetting device in order to define an actual position point associated with said track point as a point of restraint.

28. The system according to claim 26, wherein said presetting device comprises an operating unit configured to enable an operator to determine an actual position point as a point of restraint.

29. The system according to claim 26, wherein said position detection system comprises a Global Navigation Satellite System receiving device, which is coupled to position measuring devices for determining the position of said GNSS receiving device relative to the track.

30. The system according to claim 26, wherein said measuring system comprises an inertial measuring unit and position measuring devices for determining a position of said inertial measuring unit relative to the track.

31. The system according to claim 26, further comprising an evaluation device configured to calculate correction values for correcting the geometry of the track, and a control device of a track maintenance machine configured to process the correction values in order to place the track into the preset target geometry by way of a controlled lifting and lining unit.
